(19) United States
(12) Patent Application Publication
(10) Pub. No.: US 2011/0302565 A1
(43) Pub. Date: Dec. 8, 2011

(54) IMPLICIT WORKSPACE DEPENDENCIES

(76) Inventors: Michael S. Ferris, Sunnyvale, CA (US); Anders I. Bertelrud, Burlingame, CA (US); Rick Ballard, San Francisco, CA (US); Michael Rawdon, Mountain View, CA (US)

(21) Appl. No.: 13/155,285

(22) Filed: Jun. 7, 2011

Related U.S. Application Data
(60) Provisional application No. 61/352,219, filed on Jun. 7, 2010.

(51) Int. Cl. G06F 9/44

(52) U.S. Cl. 717/163

(57) ABSTRACT

Implicit dependences allow a user to add multiple independent software components to a workspace, which results in the automatic establishment of ad-hoc dependencies. If one project depends on the products of another in the same workspace, a dependency manager detects this, causing a build engine to automatically build the projects in the correct sequence. Each project retains its individual identity, so a project can be included in more than one workspace or removed from a workspace without affecting the project. The workspace module maintains pointers to the projects and other files that the workspace includes. A target and the product it creates can be related to another target. If both targets are in the same workspace, the dependency manager discovers the dependency and the build engine builds the products in the required order. Such a relationship is referred to as an implicit dependency.

### CROSS-REFERENCE TO RELATED APPLICATIONS

This application claims the benefit of U.S. Provisional Application 61/352,219, filed on Jun. 7, 2010, which is incorporated by reference in its entirety.

### BACKGROUND

1. Field of the Invention

The present invention relates generally to application development in an integrated development environment (IDE). In particular, described embodiments are directed to automatic discovery of implicit dependencies by the IDE.

2. Description of Related Art

Modern software development is typically carried out using an integrated development environment (IDE). An IDE generally provides a source code editor, a compiler, a debugger and build tools. Build tools, which collectively can be referred to as a build system, perform compiling, linking, copying and similar activities in order to produce an application or other output from inputs such as source code.

In an IDE such as Xcode, available from Apple Inc. of Cupertino, Calif., a “target” specifies a product to build and contains the instructions for building the product from a set of files in a project. A target defines a single product; it organizes the inputs into the build system—the source files and instructions for processing those source files—required to build that product.

Generally, a single project may contain a number of targets, and each target builds a single product. The particular files required by the target to build its product may themselves be products of other targets. In that event, one target is said to depend on the other target.

If a first target depends upon a second target, then the second target must be built before the first target. To ensure this, developers explicitly specify target dependencies in the IDE. Once the dependencies are specified, they are enforced during build of the project by the IDE. Thus, if the first target depends upon the second, then the IDE will build the second target before attempting to build the first. If the second target cannot be built, for example because of an error, then the IDE will typically not attempt to build the first.

### SUMMARY

The present invention enables the use of implicit workspace dependencies. Implicit dependences allow a user to add multiple independent software components to a workspace, which results in the automatic establishment of ad-hoc dependencies.

An IDE system of the present invention includes a workspace module that provides a workspace to users of the IDE system. A workspace is a container for multiple projects that the user can use to group projects and other files that are related. In one embodiment, all the projects in the workspace share the same build directory.

By relating projects in a common workspace, each project can use the products of another project while building. If one project depends on the products of another in the same workspace, a dependency manager detects this, causing a build engine to automatically build the projects in the correct sequence.

Because each file in one project is visible to the other projects in the workspace, the user does not need to copy shared libraries into each project folder separately.

Each project retains its individual identity, so a project can be included in more than one workspace or removed from a workspace without affecting the project. The workspace module maintains pointers to the projects and other files that the workspace includes. The pointers to the source files, included libraries, build configurations, and other data are stored in the project files.

A target and the product it creates can be related to another target. That is, a first target that requires the output of a second target in order to build depends upon the second. If both targets are in the same workspace, the dependency manager discovers the dependency, for example using a heuristic such as file name recognition, and the build engine then builds the products in the required order. Such a relationship is referred to as an implicit dependency. The user can also specify explicit target dependencies. For example, the user might build both a library and an application that links against that library in the same workspace. The dependency manager discovers this relationship and the build engine will automatically build the library first. However, if the user actually wants to link against a version of the library other than the one built in the workspace, the user can create an explicit dependency in the build settings, which overrides this implicit dependency. In one embodiment any or all implicit dependencies can be prevented through a preference setting or other control.

### BRIEF DESCRIPTION OF THE DRAWINGS

FIG. 1 is a block diagram of an integrated development environment system for creating implicit dependencies in accordance with an embodiment of the present invention.

FIG. 2 is a flowchart illustrating a method for creating implicit dependencies in accordance with an embodiment of the present invention.

FIG. 3 is a flowchart illustrating a method for creating implicit dependencies in accordance with an embodiment of the present invention.

FIG. 4 is a flowchart for building a build product using implicit dependencies in accordance with an embodiment of the present invention.

FIG. 5 illustrates a workspace with a single project in accordance with an embodiment of the present invention.

FIG. 6 illustrates a workspace with multiple projects in accordance with an embodiment of the present invention.

FIG. 7 is a screen shot illustrating an example view of an IDE in accordance with an embodiment of the present invention.

### DETAILED DESCRIPTION OF THE PREFERRED EMBODIMENTS

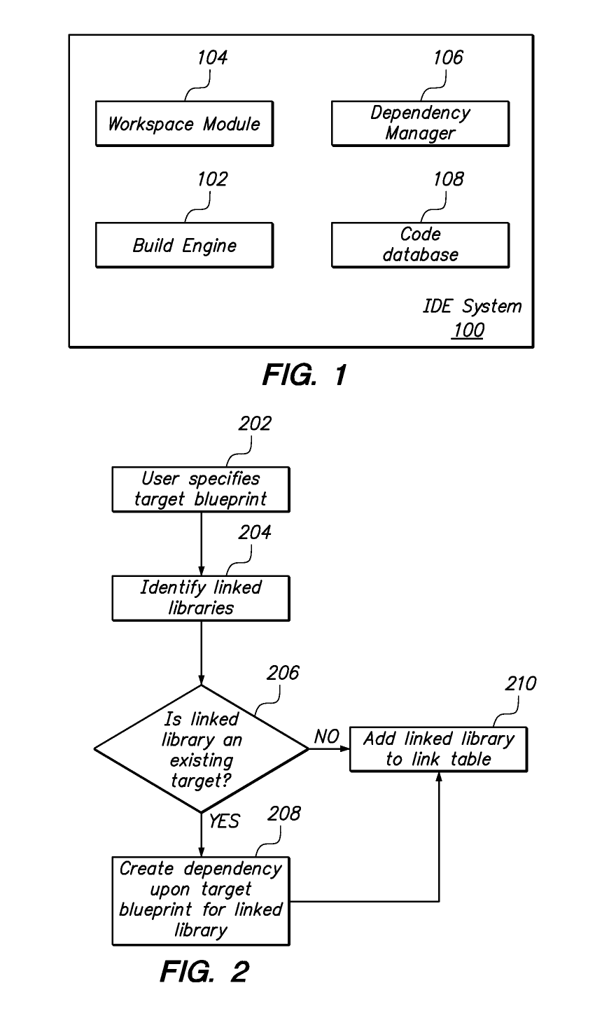

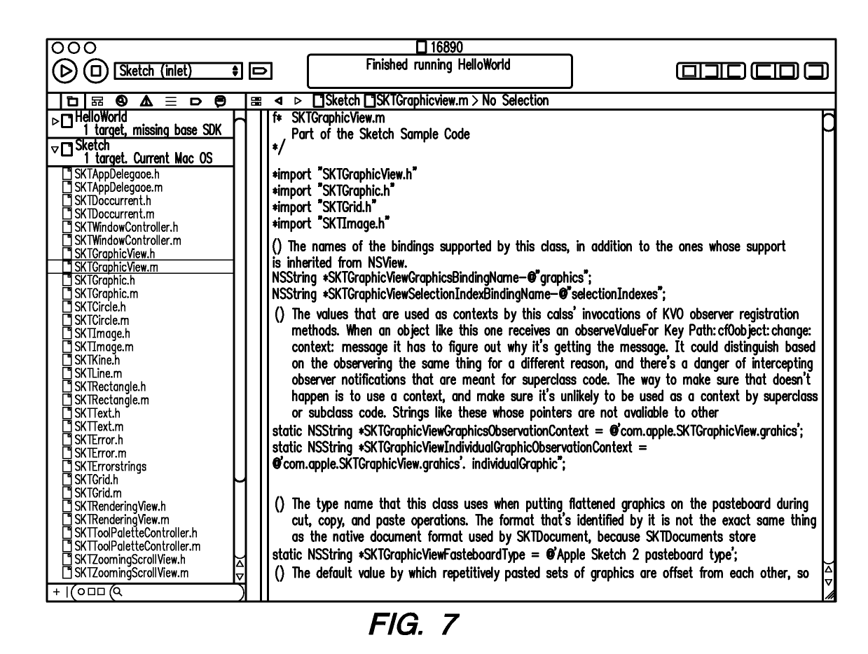

FIG. 1 illustrates a block diagram of an IDE system 100 in accordance with an embodiment of the present invention. IDE system 100 includes a workspace module 104, a build engine 102, dependency manager 106 and code database 108. Many standard components of an IDE system not germane to this description are omitted from FIG. 1 for clarity, but are well known to those of skill in the art. An example of an IDE is the Xcode IDE available from Apple Inc. of Cupertino, Calif. FIG. 7 illustrates a screen shot of an IDE.

Workspace module 104 provides functionality associated with the workspace of an IDE. For example workspace module 104 provides text-editing functionality, the ability to add and remove source folders and files from a project, specify explicit dependencies and linkages for a target, and other input/output features conventionally available in an IDE.

Code database 108 provides computer-readable data storage media for source code, object code, and other files used either by modules of IDE system 100 or by the user. Although illustrated in FIG. 1 as a single file store, those of skill will understand that code database 108 may be implemented as one or several physical or logical devices, and may be a local device or accessed via a network. The particular type of computer-readable storage media constituting code database 108 may be any combination of conventional media types.

Dependency manager 106 is responsible for tracking explicit and implicit dependencies between build targets in the workspace. Build engine 102 executes building operations to create build products. The operation of dependency manager 106 and build engine 102 are described further below.

As the user creates the code and structure of his project, he explicitly specifies the libraries each target will link against, and may also explicitly identify some of the target dependencies. Referring now to FIG. 2, the user specifies 202 the target blueprint and identifies 204 the libraries the target will link against. Dependency manager 106 checks each identified library to determine 206 whether the current workspace already has a target that produces the identified library as a product. If the linked library is already the result of an existing target, then dependency manager 106 creates 208 an implicit dependency upon the target that builds the library. In either event, a reference to the library is added 210 to a link table maintained by workspace module 104, which has a mapping of all libraries required for projects in the workspace.

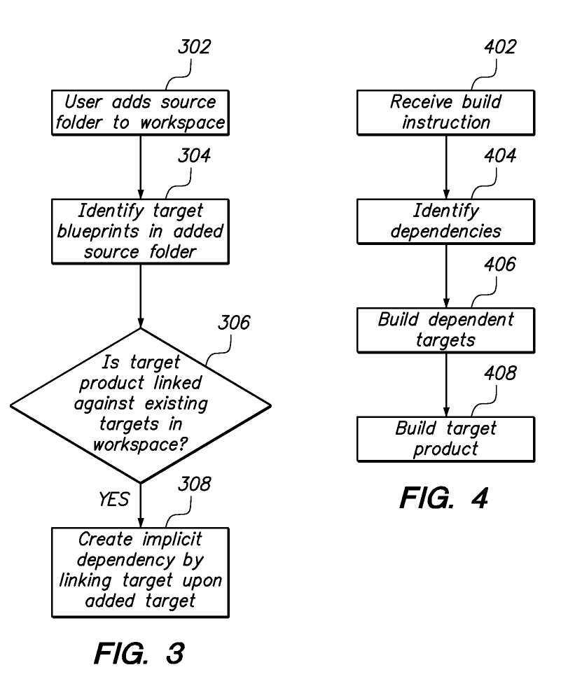

Referring to FIG. 3, if the user adds 302 a source code folder to a project in the current workspace, dependency module 106 identifies 304 the target products identified in the folder and determines 306 whether a target product of the source folder is linked against any existing targets in the workspace. If so, dependency module 106 creates 308 an implicit dependency on the newly added source code.

In one embodiment, dependency module 106 tracks both explicit and implicit dependencies by maintaining the transitive closure of a directed acyclic graph, as will be understood by those of skill in the art. The graph may be stored in a matrix or other data structure.

Referring now to FIG. 4, when the user instructs 402 IDE system 100 to build a target product, build engine 102 identifies 404 the target dependencies associated with the product being built, for example by consulting the dependencies matrix maintained by dependency module 106. Build engine 102 then builds 406 the identified dependent targets and, assuming the targets are successfully built, then builds 408 the requested target product.

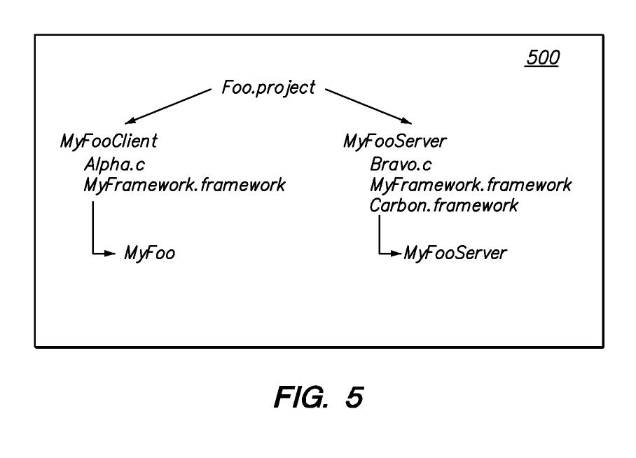

FIG. 5 illustrates a workspace 500 with a sample project, Foo.project. Foo.project has two targets, MyFooClient and MyFooServer. MyFooClient links to the framework MyFramework.framework, as does MyFooServer (which also links to Carbon.framework). When the user instructs IDE system 100 to build either target in the project, build engine 102 will link the MyFramework.framework library binary that is available, for example, in a shared library directory or a default location.

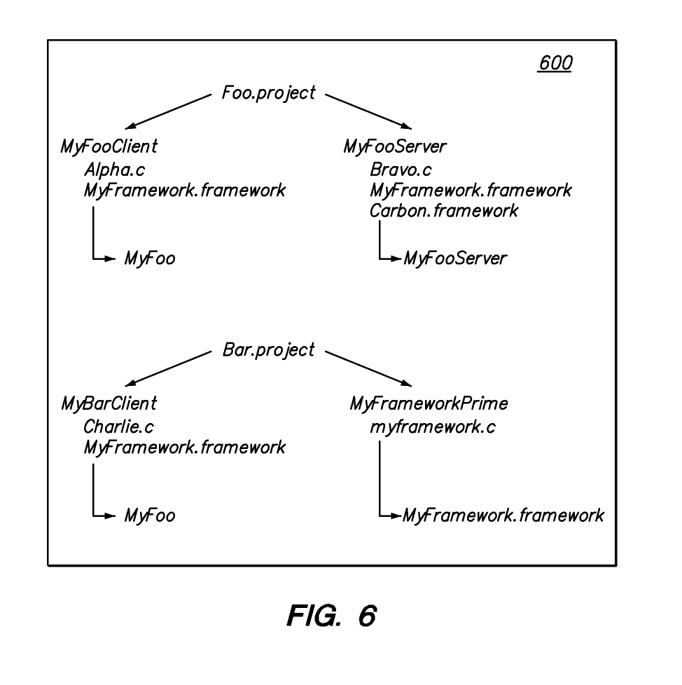

If the user then adds the MyFramework.framework source to the workspace, this results in the creation of an implicit dependency. This is illustrated by the example of FIG. 6. Workspace 600 includes the Foo.project project described above with respect to FIG. 5, as well as a second project, Bar.project. Bar.project includes two targets, MyBarClient, which links MyFramework.framework; and MyFrameworkPrime, which creates the product MyFramework.framework.

As described above, because Foo.project and Bar.project are both in the same workspace 600, dependency module 106 maintains information about the linked libraries and build products of each target in both projects. In the illustrated case, both the MyFooClient and the MyFooServer targets of the Foo.project project require the MyFramekwork.framework framework, though the user has not specified an explicit dependency on the MyFrameworkPrime target that produces that framework. Dependency module 106, however, identifies the product MyFramework.framework of target MyFrameworkPrime as linked against both targets of the Foo.project project and also of the MyBarClient target of the Bar.project project. Dependency module 106 therefore creates an implicit dependency by MyFooClient, MyFooServer and MyBarClient on MyFrameworkPrime. As a result, build engine 102 will ensure that MyFramework.framework is produced prior to the other products, and is then linked against them. This differs from the case illustrated by FIG. 5, in which source code was not in the same workspace, and the library binary was simply linked. Here, the created implicit dependency causes the library to be compiled from the source present in the workspace rather than allowing build engine 102 to simply link against the shared library version.

In one embodiment, removing a source code folder from the workspace causes dependency manager 306 to remove any implicit dependencies that depend upon the target in the removed folder.

In one embodiment, implicit dependencies are created (and removed) automatically by dependency manager 306 as described above. In an alternative embodiment, IDE system 100 asks the user to confirm or reject the establishment of a dependency, either as the potential implicit dependencies are identified, or alternatively at build time.

The present invention has been described in particular detail with respect to a limited number of embodiments. Those of skill in the art will appreciate that the invention may additionally be practiced in other embodiments.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “selecting” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for building a software application using an integrated development environment, the environment including a workspace, the method comprising:
receiving a first build target, the first build target specifying a first build product and a library to be linked;
determining that source code for the library to be linked is present in the workspace, the source code having an associated build target and build product;
establishing a dependency upon the build product associated with the source code;
receiving a request to build the first build product;
building, in response to the request, the build product associated with the library source code; and
building the first build product.

2. The method of claim 1 further comprising:
determining that the source code for the library to be linked is no longer present in the workspace; and
removing the dependency upon the build product associated with the source code.

3. The method of claim 2 wherein removing the dependency upon the build product associated with the source code further comprises requesting confirmation from a user of the integrated development environment to remove the dependency.

4. The method of claim 3 wherein the request for confirmation is made at build time.

5. The method of claim 1 wherein establishing the dependency upon the build product further comprises requesting confirmation from a user of the integrated development environment to establish the dependency.

6. The method of claim 5 wherein the request for confirmation is made at build time.

7. A computer program product for building a software application using an integrated development environment having a workspace, the computer program product stored on a non-transitory computer-readable medium, the computer program product including executable code that when executed by a processor carries out the steps of:
receiving a first build target, the first build target specifying a first build product and a library to be linked;
determining that source code for the library to be linked is present in the workspace, the source code having an associated build target and build product;
establishing a dependency upon the build product associated with the source code;
receiving a request to build the first build product;
building, in response to the request, the build product associated with the library source code; and
building the first build product.

8. A method for building a software application using an integrated development environment, the environment including a workspace, the method comprising:
receiving a first build target, the first build target specifying a first build product and a first library to be linked;
responsive to addition of a source code folder to the workspace:
determining a second build target identified in the folder, the second build target specifying a second build product;
responsive to the second build product being linked against the first build target, establishing a dependency upon the build product associated with the second build target;
receiving a request to build the first build product;
building, in response to the request, the build product associated with the second build target; and
responsive to the build of the second build product being successful, building the first build product.
